(19) United States
(12) Patent Application Publication
(10) Pub. No.: US 2025/0074236 A1
(43) Pub. Date: Mar. 6, 2025

(54) EXTREME FAST-CHARGING SYSTEMS AND ASSOCIATED METHODS

(71) Applicant: Edison Technologies Inc., Las Vegas, NV (US)

(72) Inventors: Kong Hian Lee, Las Vegas, NV (US); Joseph H. Armstrong, Greeley, CO (US)

(21) Appl. No.: 18/771,953

(22) Filed: Jul. 12, 2024

Related U.S. Application Data
(60) Provisional application No. 63/579,198, filed on Aug. 28, 2023.

(51) Int. Cl. B60L 53/53; B60L 53/51; B60L 53/52; B60L 53/56; B60L 53/63; B60L 53/64

(52) U.S. Cl. CPC B60L 53/53; B60L 53/51; B60L 53/52; B60L 53/56; B60L 53/63; B60L 53/64; B60L 2210/10; B60L 2210/30

(57) ABSTRACT

An extreme fast-charging (XFC) system for electric vehicles includes (i) a direct current (DC) electric power bus and (ii) an electric vehicle (EV) charging station electrically coupled to the DC electric power bus without use of rectification circuitry. A method for XFC of one or more EVs includes (i) using a controller, electrically coupling one or more batteries to a DC electric power bus and (ii) powering one or more EV charging stations electrically coupled to the DC electric power bus without converting DC electric power on the DC electric power bus to alternating current (AC).

### RELATED APPLICATIONS

This application claims benefit of U.S. Provisional Patent Application No. 63/579,198, filed on Aug. 28, 2023, which is incorporated herein by reference.

### BACKGROUND

The re-emergence of electric vehicles (EVs) after nearly a century has come about due to advances in battery storage and high-efficiency brushless motor technologies. This combination of technological advancement, and resultant reduction in cost, has allowed for the range of an EV to be on par with the range of an internal combustion engine (ICE) vehicle between refueling. As EV range has been addressed, EV charging has become a challenge as it typically takes significantly longer to charge an EV than to refuel an ICE vehicle. Widespread adoption of EVs will require charging to be of similar duration to refueling of ICE vehicles.

### BRIEF DESCRIPTION OF THE DRAWINGS

FIG. 1 is a schematic diagram of a conventional Level 3 charging system.

FIG. 2 is a schematic diagram of an electrical environment including an extreme fast-charging (XFC) system with a main direct current (DC) electric power bus and an electrochemical energy storage system, according to an embodiment.

FIG. 3 is a schematic diagram of an electrical environment including an alternate embodiment of the FIG. 2 XFC system where batteries are replaced with an electromechanical energy storage system, such as an inertial flywheel storage unit.

FIG. 4 is a schematic diagram of one embodiment of a controller of the FIG. 2 XFC system.

FIG. 5 is a schematic diagram of another embodiment of the controller of the FIG. 2 XFC system.

FIG. 6 is a block diagram of one embodiment of an Energy Management System (EMS) of the FIG. 2 XFC system.

FIG. 7 is a schematic diagram of an electrical environment including an embodiment of the FIG. 2 XFC system where collective magnitude of electric power flowing to electric vehicle (EV) charging stations exceeds a capacity of an alternating current (AC) electric power grid at a location of the XFC system.

FIG. 8 is an illustration of an example of electric power flow in the FIG. 2 electrical environment where batteries and a photovoltaic (PV) array jointly power EV charging stations.

FIG. 9 is an illustration of an example of electric power flow in the FIG. 2 electrical environment where solely the batteries power the EV charging stations.

FIG. 10 is an illustration of an example of electric power flow in the FIG. 2 electrical environment where the PV array simultaneously charges the batteries and powers the EV charging stations.

FIG. 11 is an illustration of an example of electric power flow in the FIG. 2 electrical environment where an AC electric power grid and the batteries jointly power the EV charging stations.

FIG. 12 is an illustration of an example of electric power flow in the FIG. 2 electrical environment where the AC electric power grid simultaneously charges the batteries and powers the EV charging stations.

FIG. 13 is an illustration of an example of electric power flow in the FIG. 2 electrical environment where solely the AC electric power grid powers the EV charging stations.

FIG. 14 is an illustration of an example of electric power flow in the FIG. 2 electrical environment where solely the batteries power the EV charging stations and electric power produced by the PV array is provided to the AC electric power grid.

FIG. 15 is an illustration of an example of electric power flow in the FIG. 2 electrical environment where the batteries power the EV charging stations and the batteries also provide electric power to the AC electric power grid.

FIG. 16 is a schematic diagram of an electrical environment including an alternate embodiment of the FIG. 2 XFC system where the main DC electric power bus extends beyond the XFC system to power one or more auxiliary DC loads.

FIG. 17 is a schematic diagram of an electrical environment including an alternate embodiment of the FIG. 2 XFC system where certain DC/DC converters are omitted.

### DETAILED DESCRIPTION OF THE EMBODIMENTS

Charging of electric vehicles (EVs) in the United States can be broken down into three categories, or Levels. Level 1 charging is the lowest charging level as it utilizes household wiring (which is typically a 120 volt alternating current (VAC) single phase circuit) and can account for 2.5 to 5 miles per one hour of charge. As Level 1 charging uses common household wiring, it can be considered a baseline, emergency charging method. Level 2 charging involves a 220 VAC to 240 VAC single phase circuit, commonly associated with an electric range or a clothes dryer, and accounts for a dramatic increase in charging rate over Level 1 charging, effectively increasing the range to 30-40 miles per one hour of charge. Another advantage of Level 2 charging is that requisite supporting circuits can be easily accommodated both at homes and businesses. As such, Level 2 charging infrastructure is becoming popular at hotels, apartments, and other locations where charging is not time sensitive. Level 3 charging, commonly referred to as DC Fast Charging that is rated at 50 kW or higher, involves a higher level of electrical service, typically a three-phase circuit that is commonplace in businesses and factories, but is not available in residential applications. These three-phase circuits are commonly 208 VAC or 480 VAC and can account for 60-80 miles range in only 20 minutes of charging. Level 3 charging can include what has been recently begun to be referred to as extreme fast-charging (XFC) that requires an EV capable of accepting over 300 kW of direct current (DC) power and usually is indicative of EV battery packs being rated at 800 volts direct current (VDC) or above. With XFC, it is possible for an EV to charge from 10 percent to 80 percent capacity in under 10 minutes, or effectively close to the equivalent duration of an internal combustion engine (ICE) vehicle refueling experience.

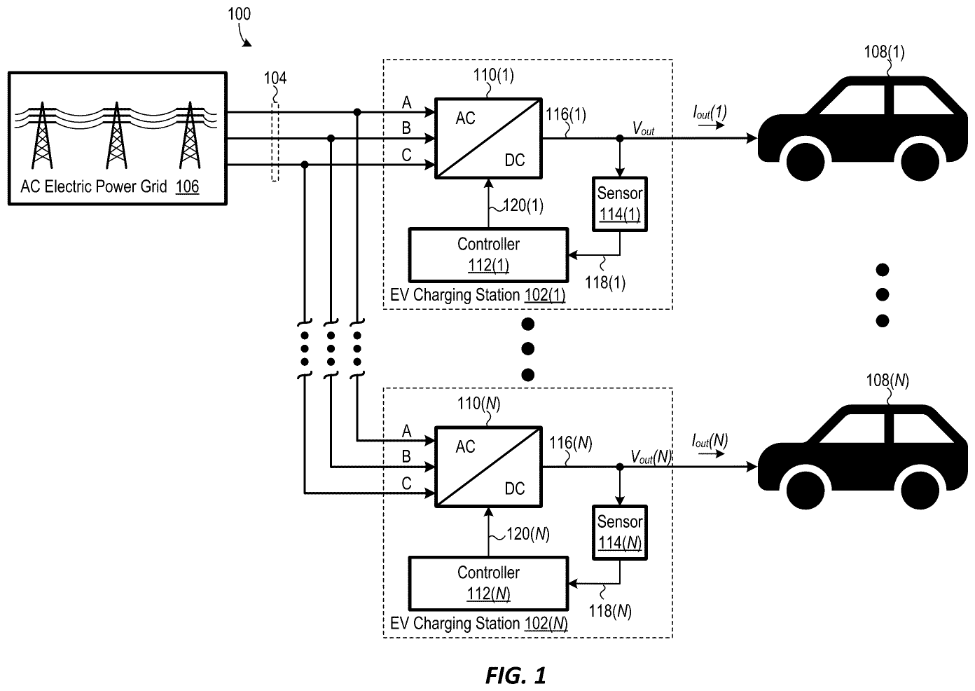

However, conventional Level 3 charging systems, particularly those rated at over 150 kW, are frequently unable to provide such fast advertised rates of charging under typical operating conditions. For example, FIG. 1 is a schematic diagram of a conventional Level 3 charging system 100 including N electric vehicle charging stations 102 and a three-phase connection 104, where Nis an integer that is greater than one. In this document, specific instances of an item may be referred to by use of a numeral in parentheses (e.g. EV charging station 102(1)) while numerals without parentheses refer to any such item (e.g. EV charging stations 102). Three-phase connection 104 electrically couples each EV charging station 102 to an alternating current (AC) electric power grid 106, and three-phase connection 104 includes three phases, i.e., phase A, phase B, phase C. Each EV charging station 102 is depicted as charging a battery (not shown) of a respective EV 108.

Each EV charging station 102 includes respective rectification circuitry 110, a respective controller 112, and a respective sensor 114. In each EV charging station 102, the rectification circuitry 110 is configured to convert AC electric power from three-phase connection 104 to DC electric power on a respective DC electric power bus 116, for charging the battery of a respective EV 108. In this document, the term “rectification circuitry” refers to circuitry that converts AC electric power to DC electric power. Additionally, in this document “rectification circuitry” may also perform one or more functions in addition to converting AC electric power to DC electric power. For example, each instance of rectification circuitry 110 in FIG. 1 may be implemented by a respective AC-to-DC converter that regulates magnitude of voltage Vₒᵤₜ and electric current Iₒᵤₜ on its respective DC electric power bus 116, as well as converts AC electric power to DC electric power. Each sensor 114 generates one or more feedback signals 118 representing magnitude of voltage Vₒᵤₜ and/or electric current Iₒᵤₜ on its respective DC electric power bus 116, and each controller 112 generates control signals 120 based at least partially on respective feedback signals 118 to control respective rectification circuitry 110 to ideally provide up 350 kilowatts (kW) of electric power for charging the battery of a respective EV 108.

While Level 3 charging system 100 may be capable of charging a single EV 108 at a high rate, Level 3 charging system 100 is typically incapable of simultaneously supporting XFC charging of multiple EVs 108, in part due to capacity limitations of AC electric power grid 106 at the location of Level 3 charging system 100. For example, AC electric power grid 106 may not have sufficient capacity at the location of multiple ports of Level 3 charging system 100 to provide over 350 kW of power to each. Additionally, AC electric power grid 106 capacity may be further constrained from time-to-time due to impairments of AC electric power grid 106, such as brown-outs (reduced capacity) or black-outs (electric power grid failure), which further limit ability of Level 3 charging system 100 to charge EVs 108 at a high rate. Furthermore, cost of energy from AC electric power grid 106 may vary, such as according to demand and time of day, and an operator of Level 3 charging system 100 may therefore further limit EV 108 charging rate at times of high energy cost to prevent incurring excess costs.

As such, conventional Level 3 charging systems, such as the system of FIG. 1, are frequently incapable of simultaneous XFC of multiple EVs, especially during periods of high demand and/or when an AC electric power grid is impaired. At the same time, EVs are increasingly being designed with high voltage battery packs (>800 VDC) capable of handling the full 350 kW power level associated with XFC, provided that the battery charge state is sufficient, which is exasperating the aforementioned drawbacks of conventional, grid-dependent Level 3 charging systems. Accordingly, EV driver experience, even at Level 3 charging stations purporting to support XFC, is seldom as advertised, thereby requiring a longer charging time than should be needed, and many EV charging stations in urban areas often have long waiting lines that further degrade the EV charging experience.

Applicant has also found that conventional Level 3 charging systems suffer significant power loss. In particular, conventional Level 3 charging systems require multiple power conversions through an electrical power train that transmits electric power from a generator source to an EV battery. Most electric power grids are configured to provide AC electric power, with the highest power ratings being provided using a three-phase circuit, where three separate power lines transmit at different phases of 50-60 Hertz (Hz) line frequency (0°, 120°, 240) to maximize transmitted power. When the electric power grid is connected to a Level 3 charging system through an isolation transformer, the voltage of the electric power grid (nominally 480 VAC) is isolated by, and adjusted to, the voltage required by an EV charging station. Each phase is connected to an EV charging station that converts the AC electric power to DC electric power using rectification circuitry, where the DC electric power is at a requisite DC voltage for the EV charging station. Despite the considerable advancement of high-power electric circuitry, each conversion from AC electric power to DC electric power, or adjustment of voltages using either a transformer (AC/AC) or a DC/DC converter, typically results in one percent to five percent power loss. These power losses can be very significant, especially when simultaneously charging multiple EVs and when multiple power conversion steps are performed along an electrical power train transmitting electric power from a generator source to an electric vehicle battery.

One possible solution to the aforementioned drawbacks of conventional Level 3 charging systems is to combine an AC electric power grid with alternate electric power sources, such as renewable electric power sources, and to employ battery-based energy storage systems (BESS), both of which can contribute to charging power and can ultimately share some of the load from the AC electric grid for charging operations. This use of a microgrid-based system would alleviate the load experienced by the AC electric grid, but it adds complexity and several additional AC/DC conversions as historically solar photovoltaic power is converted from DC to AC through an inverter to be fed to its electrical load, and wind energy usually starts as AC. Internally, BESS must be DC to allow for energy storage in batteries, but as BESS typically are connected to an AC electric power grid, BESS will therefore require conversion from and to AC when interfaced to the outside world. Thus, while use of alternative electric power sources may compensate for inadequate capacity of an AC electric power grid at a Level 3 charging system, it adds complexity and may further increase power loss due to increased power conversion requirements.

Disclosed herein are XFC systems and associated methods which at least partially overcome the above-discussed drawbacks of conventional Level 3 charging systems. Certain embodiments of the new XFC systems and methods advantageously enable an EV owner to charge their EV at a speed comparable to that of refueling an ICE vehicle, even when multiple EVs are being simultaneously charged at the same site. In particular embodiments, one or more EV charging stations are powered from a DC power bus, instead of from an alternating current AC power bus, which promotes low power loss and operational simplicity. Additionally, certain embodiments include one or more batteries configured to provide energy to one or more EV charging stations, and the one or more batteries are optionally partially or fully charged via one or more renewable electric power sources. Furthermore, some embodiments include an AC grid interconnection that is used solely when the combination of renewable electric power sources and battery-supplied power is unable to provide sufficient electric power to the XFC system.

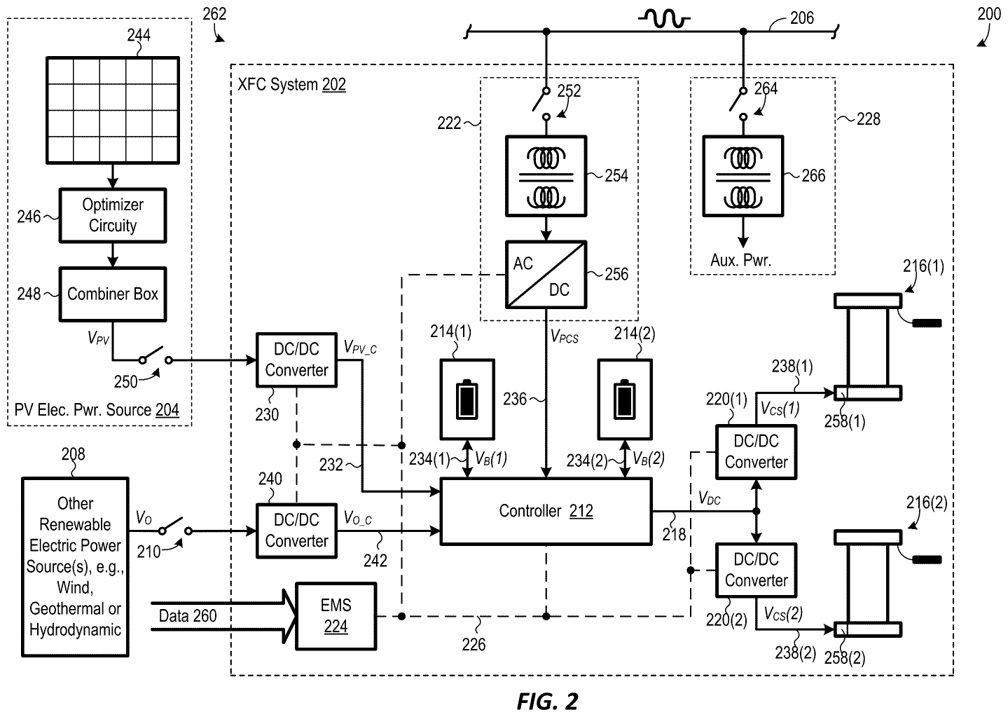

FIG. 2 is a schematic diagram of an electrical environment 200 including an XFC system 202, where XFC system 202 is one embodiment of the new XFC systems disclosed herein. Electrical environment 200 further includes a photovoltaic (PV) electric power source 204 and an AC electric power grid 206. Electrical environment 200 optionally also includes one or more other renewable electric power sources 208 and an associated power disconnect switch 210. While PV electric power source 204, other renewable electric power sources 208, and power disconnect switch 210 are depicted as being separate from XFC system 202, in some alternate embodiments, one or more of these elements are partially or fully incorporated with XFC system 202. For example, in some alternate embodiments, PV electric power source 204 is incorporated with XFC system 202, such as when PV electric power source 204 is at the same location as XFC system 202.

XFC system 202 includes a controller 212, batteries 214, EV charging stations 216, a main DC electric power bus 218, a respective DC/DC converter 220 for each EV charging station 216, a AC electric power source 222, an Energy Management System (EMS) 224, a low voltage data control line 226, an auxiliary power system 228, a DC/DC converter 230, a DC electric power bus 232, a respective DC electric power bus 234 for each battery 214, a DC electric power bus 236, and a respective DC electric power bus 238 for each EV charging station 216. XFC system 202 optionally further includes a DC/DC converter 240 and a DC electric power bus 242 associated with other renewable electric power sources 208. While XFC system 202 is depicted as including two batteries 214, the quantity of batteries 214 of XFC system 202 may vary. Additionally, although XFC system 202 is depicted as including two EV charging stations 216, the quantity of EV charging stations 216 may also vary. For example, XFC system 202 could alternately include only a single EV charging station 216, or XFC system 202 could alternately include three or more EV charging stations 216.

XFC system 202 is designed to utilize state-of-the-art and future battery technologies capable of reaching significant charge capacity in a short amount of time, a feature that is in significant demand with the emerging EV market. For example, particular embodiments of XFC system 202 are designed to ensure that power provided to an EV is the most economical to the consumer by using renewable energy, e.g., PV electric power source 204 and/or other renewable electric power sources 208, as the primary electric power source and only using AC electric power source 222 as a backup electric power source, and by ensuring that system losses by unnecessary rectification/inverting functions are eliminated. Thus, in certain embodiments, the bulk of XFC system 202 consists of DC electric power buses, with AC electric power source 222 providing electric power as a backup only. However, it is understood that XFC system 202 could be modified to include additional elements without departing from the scope hereof.

PV electric power source 204 includes a PV array 244, optimizer circuitry 246, a combiner box 248, and a power disconnect switch 250. In one embodiment, PV array 244 is sized to provide sufficient electric power to XFC system 202, e.g., to meet anticipated demand of EV charging stations 216, discussed below. Output of PV array 244 is optimized by optimizer circuitry 246 that includes a maximum peak power tracker (MPPT), sometimes alternately referred to as a maximum power point tracker, and associated circuitry, to ensure help ensure maximum PV array 244 output by adjusting its input impedance such that PV array 244 operates at its maximum power point. Combiner box 248 is used to ensure a single power lead from PV electric power source 204 into XFC system 202, such as by combining electrical outputs of one or more optional additional PV arrays (not shown) with the output of PV array 244. Combiner box 248 is electrically coupled to DC/DC converter 230 by power disconnect switch 250. The configuration of PV electric power source 204 may vary as long as it is capable of providing DC electric power to XFC system 202. For example, the functions of the PV modules in PV array 244 and optimizer circuitry 246 may alternately be combined and then fed into the combiner box 248. As another example, optimizer circuitry 246 may be located downstream of combiner box 248 instead of upstream of combiner box 248. As an additional example, in certain alternate embodiments, combiner box 248 is capable of performing MPPT, and optimizer circuitry 246 is therefore omitted. As another example, optimizer circuitry 246 may be disbursed among PV modules of PV array 244, or as a bulk MPPT for a given string or strings of photovoltaic devices of PV array 244. Additionally, some functionality of PV electric power source 204 may be incorporated in XFC system 202. For example, in particular alternate embodiments, DC/DC converter 230 is capable of performing MPPT and optimizer circuitry 246 is therefore omitted.

Electric power provided by PV electric power source 204 can be energized and de-energized by power disconnect switch 250. When power disconnect switch 250 is closed, electric power generated by PV electric power source 204 goes through high-efficiency DC/DC converter 230 to match its voltage output to that necessary to power XFC system 202. Specifically, DC/DC converter 230 converts a voltage magnitude V_{PV} of electric power generated by PV array 244 to a voltage magnitude V_{PV_C} on DC electric power bus 232, where DC electric power bus 232 electrically couples DC/DC converter 230 to controller 212. DC/DC converter 230 is optional if voltage magnitude V_{PV} is already matched to XFC system 202. Other renewable electric power sources 208 can also be incorporated to provide the necessary power to XFC system 202. Other renewable electric power sources 208 can include, but are not limited to, wind, geothermal, and hydrodynamic electric power sources, provided that this power is predominantly DC (or is converted to DC before reaching XFC system 202). Similar to PV electric power source 204, energizing and de-energizing other renewable electric power sources 208 goes through power disconnect switch 210 and then through DC/DC converter 240 to match the necessary voltage of XFC system 202. Specifically, DC/DC converter 240 converts a voltage magnitude V_{O} of electric power generated by other renewable electric power sources 208 to a voltage magnitude V_{O_C} on DC electric power bus 242, where DC electric power bus 242 electrically couples DC/DC converter 240 to controller 212. In some alternate embodiments, DC/DC converter 240 is omitted, such as if voltage magnitude V_{O} is already matched to voltage of XFC system 202.

AC electric power source 222 includes a power disconnect switch 252, an isolation transformer 254, and a power conversion system (PCS) 256. PCS 256 is electrically coupled to AC electric power grid 206 via the series combination of power disconnect switch 252 and isolation transformer 254. AC electric power grid 206 provides a backup source of electric power to XFC system 202 via AC electric power source 222. Electric power from AC electric power grid 206 is likely to be more expensive than electric power from PV electric power source 204 and other renewable electric power sources 208, but AC electric power grid 206 may be inherently more reliable than PV electric power source 204 or other renewable electric power sources 208. After energizing/de-energizing via power disconnect switch 252, isolation transformer 254 is employed to protect AC electric power grid 206 as well as equipment of XFC system 202 connected to AC electric power grid 206. Electric power from isolation transformer 254 is provided to PCS 256 that rectifies the AC electric power to DC electric power having a voltage magnitude V_{PCS} and is matched, for example, to the needs of batteries 214. Accordingly, PCS 256 is powered from AC electric power grid 206 via isolation transformer 254 and power disconnect switch 252. PCS 256 is electrically coupled to controller 212 via DC electric power bus 236.

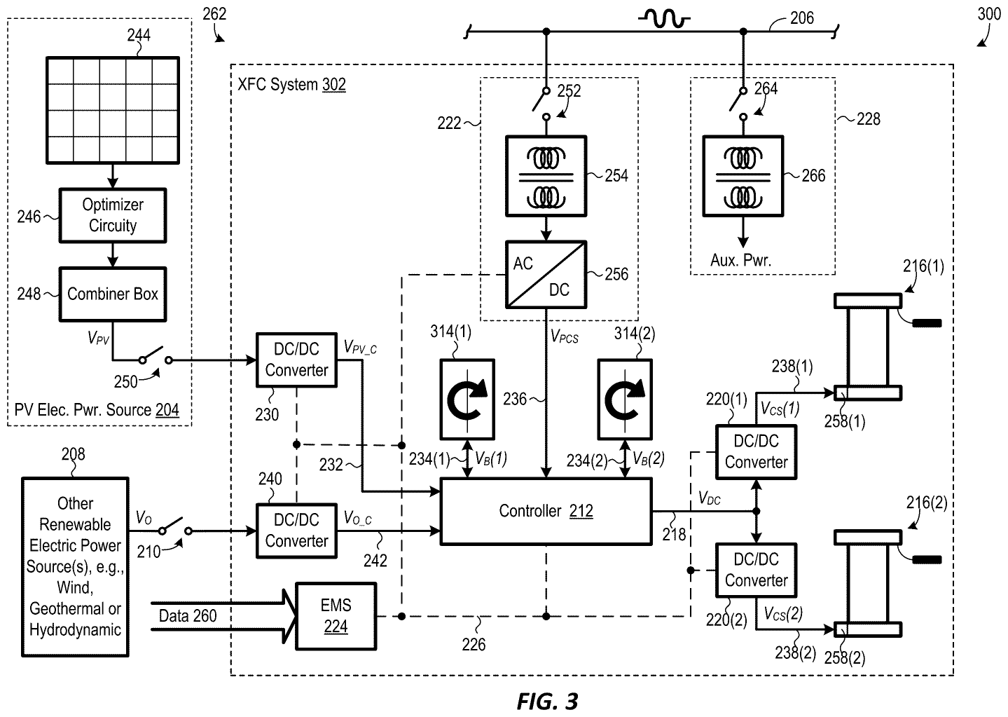

Batteries 214 serve as DC electric energy storage systems in XFC system 202 and are capable of powering XFC system 202. Within a 24 hour cycle, battery 214 charging options may vary depending upon conditions. Each battery 214 is electrically coupled to controller 212 via a respective DC electric power bus 234. In particular embodiments, each battery 214 is a high-capacity battery, e.g., a Lithium ion battery. Each battery 214 may include equipment, such as a charging controller and power conversion equipment, in addition to electrochemical cells. Each battery 214 provides DC electric power having a respective voltage magnitude V_{B} on its respective DC electric power bus 234, where voltage magnitudes V_{B} are designed to meet XFC system 202 requirements. Batteries 214 could be supplemented by, or replaced with, other DC energy storage systems, including but not limited to inertial flywheel storage units. For example, FIG. 3 is a schematic diagram of an electrical environment 300 where XFC system 202 is replaced with an XFC system 302. XFC system 302 is an alternate embodiment of XFC system 202 where batteries 214 are replaced with inertial flywheel storage units 314.

Referring again to FIG. 2, electric power from AC electric power grid 206 via AC electric power source 222, electric power from PV electric power source 204, and electric power from other renewable electric power sources 208, is provided to controller 212 via DC electric power buses 236, 232, and 242, respectively, and the provided electric power is available for charging batteries 214 and/or powering EV charging stations 216. Controller 212 includes, for example, one or more switching devices, such as relays, transistors, contactors, or the like (not shown), that are configured to selectively electrically couple one or more electric power sources, e.g., PV electric power source 204, other renewable electric power sources 208, and/or AC electric power source 222, to one or more loads, e.g., batteries 214 and/or EV charging stations 216, such as in response to signals from EMS 224. Main DC electric power bus 218 exits controller 212 and is electrically coupled to one or more EV charging stations 216, each with an optional DC/DC converter 220 to match voltage magnitude V_{DC} of main DC electric power bus 218 to respective DC-only inputs 258 of EV charging stations 216. Specifically, each DC/DC converter 220 is electrically coupled to controller 212 via main DC electric power bus 218, and each EV charging station 216 is electrically coupled to its respective DC/DC converter 220 via its respective DC electric power bus 238. Each DC/DC converter 220 is configured to convert electric power voltage magnitude V_{DC} on main DC electric power bus 218 to a respective electric power voltage magnitude V_{CS} on its respective DC electric power bus 238.

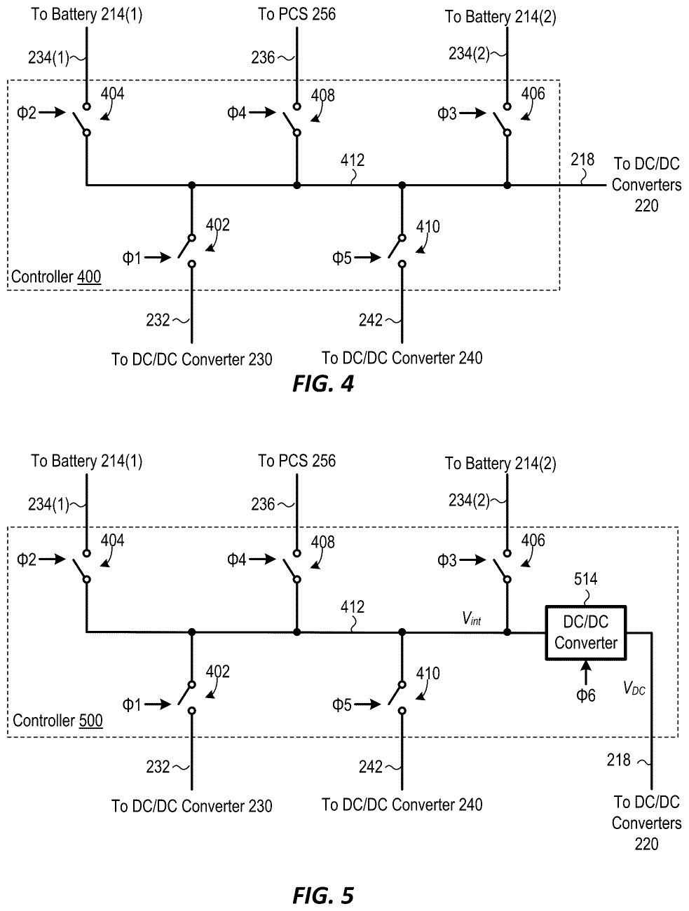

In certain embodiments, voltage magnitude V_{PV_C}, voltage magnitude V_{O_C}, voltage magnitude V_{PCS}, and voltage magnitudes V_{B} are each equal to voltage magnitude V_{DC}, such that controller 212 need not perform voltage magnitude transformation, thereby promoting high efficiency and simplicity by eliminating the need for voltage magnitude transformation in controller 212. For example, FIG. 4 is a schematic diagram of a controller 400, which is one possible embodiment of controller 212 that does not perform voltage magnitude transformation. Controller 400 includes a switching device 402, a switching device 404, a switching device 406, a switching device 408, a switching device 410, and an internal DC electric power bus 412. Each switching device 402-410 includes, for example, one or more relays, transistors, contactors, or the like. Switching device 402 is electrically coupled between DC electric power bus 232 and internal DC electric power bus 412, and switching device 402 is controlled by a control signal Φ1. Switching device 404 is electrically coupled between DC electric power bus 234(1) and internal DC electric power bus 412, and switching device 404 is controlled by a control signal Φ2. Switching device 406 is electrically coupled between DC electric power bus 234(2) and internal DC electric power bus 412, and switching device 406 is controlled by a control signal Φ3. Switching device 408 is electrically coupled between DC electric power bus 236 and internal DC electric power bus 412, and switching device 408 is controlled by a control signal Φ4. Switching device 410 is electrically coupled between DC electric power bus 242 and internal DC electric power bus 412, and switching device 410 is controlled by a control signal Φ5. Internal DC electric power bus 412 is electrically coupled to main DC electric power bus 218. EMS 224 is configured to generate control signals Φ1, Φ2, Φ3, Φ4, and Φ5, and low voltage data control line 226 transmits control signals Φ1, Φ2, Φ3, Φ4, and Φ5 from EMS 224 to controller 400.

EMS 224 is configured to generate control signals Φ1, Φ2, Φ3, Φ4, and Φ5 to control flow of electric power in XFC system 202. For example, EMS 224 may cause electric power from PV electric power source 204 to flow to batteries 214 and to EV charging stations 216, for charging batteries 214 and powering EV charging stations 216, respectively, by generating control signals Φ1, Φ2, Φ3, Φ4, and Φ5 such that (i) each of switching devices 402, 404, and 406 is closed and (ii) each of switching devices 408 and 410 is open. As another example, EMS 224 may cause electric power from AC electric power source 222 to flow to batteries 214 and to EV charging stations 216, for charging batteries 214 and powering EV charging stations 216, respectively, by generating control signals Φ1, Φ2, Φ3, Φ4, and Φ5 such that (i) each of switching devices 404, 406, and 408 is closed and (ii) each of switching devices 402 and 410 is open. As an additional example, EMS 224 may cause electric power from batteries 214 to flow to EV charging stations 216, for powering EV charging stations 216 without charging batteries 214, by generating control signals Φ1, Φ2, Φ3, Φ4, and Φ5 such that (i) each of switching devices 404 and 406 is closed and (ii) each of switching devices 402, 408, and 410 is open.

Controller 400 could be modified to support additional functionality. For example, controller 400 could be modified to include one or more additional switching devices to enable simultaneous charging of batteries 214 from one of PV electric power source 204 and AC electric power source 222 while powering EV charging stations 216 from the other of PV electric power source 204 and AC electric power source 222.

Referring again to FIG. 2, in some other embodiments, one or more of voltage magnitude V_{PV_C}, voltage magnitude V_{O_C}, voltage magnitude V_{PCS}, and voltage magnitudes V_{B} differ from voltage magnitude V_{DC}, and in these embodiments, controller 212 necessarily includes one or more DC-to-DC converters to perform voltage magnitude transformation. For example, FIG. 5 is a schematic diagram of a controller 500, which is one possible embodiment of controller 212 that is capable of performing voltage magnitude transformation. Controller 500 is like controller 400 except that controller 500 further a DC/DC converter 514 electrically coupled between internal DC electric power bus 412 and main DC electric power bus 218. DC/DC converter 514 is configured to convert electric power voltage magnitude Vᵢₙₜ on internal DC electric power bus 412 to electric power voltage magnitude V_{DC} on main DC electric power bus 218 in response to a control signal Φ6 generated by EMS 224. In some embodiments, EMS 224 is configured to control DC/DC converter 514 such that DC/DC converter 514 only operates when needed. For example, assume a hypothetical scenario where each of voltage magnitude V_{PV_C}, voltage magnitude V_{PCS}, and voltage magnitudes V_{B} is equal to voltage magnitude V_{DC}, but voltage magnitude V_{O_C} differs from voltage magnitude V_{DC}. In this scenario, EMS 224 could be configured such that (i) DC/DC converter 514 operates as a voltage conversion device when switching device 410 is closed and (ii) DC/DC converter 514 operates in a bypass mode when switching device 410 is open. The bypass mode is characterized, for example, by DC/DC converter 514 connecting internal DC electric power bus 412 to main DC electric power bus 218 without performing power conversion.

Referring again to FIG. 2, in order to ensure the proper operation of XFC system 202, EMS 224 provides a proprietary logic code for (i) controlling controller 212 to select between PV electric power source 204, AC electric power source 222, and other renewable electric power sources 208, for powering XFC system 202, (ii) selecting the rate and sequence of charging batteries 214, (iii) regulating and monitoring all DC/DC converters 220, 230, and 240, and (iv) regulating and monitoring PCS 256, via low voltage data control line 226 that can use a wide range of one or more protocols. As PV electric power source 204 and other renewable electric power sources 208 can vary in their capacity, it is important to know the current state of these electric power sources, as well as those predicted in the immediate future, to allow for tapping into AC electric power grid 206 as necessary, with a preference to time AC electric power grid 106 access to the lowest cost rate. Control of an input electric power source by EMS 224 is specifically focused upon power stored in batteries 214 for use by the EV charging stations 216 being the most economical. Coding used in EMS 224 may include any data 260 that might alter the amount of power capacity, both present and projected, that is available from PV electric power source 204, AC electric power source 222, and other renewable electric power sources 208, based on, but not limited to, solar insolation, wind, and temperature. In some embodiments, data 260 is received by EMS 224 via the Internet. Solar insolation affects capacity of PV array 244 and can be affected by natural events (sun angle, cloud obscuration, environmental interactions from fires, etc.), and human-generated events that otherwise obscure sunlight's availability to reach the solar arrays. Likewise, other renewable electric power sources 208 can also vary available capacity. Capacity of batteries 214, for example, shall be monitored and predicted upon battery life cycle and health, operational temperature, and depth of discharge history. Some embodiments of EMS 224 are also configured to use mining of data 260 of available vehicle information from typical EV systems to predict trends in demand to ensure that sufficient capacity is stored in batteries 214 to minimize or eliminate the need for electric power from AC electric power grid 206, within the constraints of capacity of PV electric power source 204 and other renewable electric power sources 208. Mining of data 260 can occur either in EMS 224 or from a central location and appropriate responses sent to EMS 224. In some alternate embodiments, low voltage data control line 226 is replaced by, or supplemented with, one or more a high voltage data control line, an optical control line, a wireless communication link, etc.

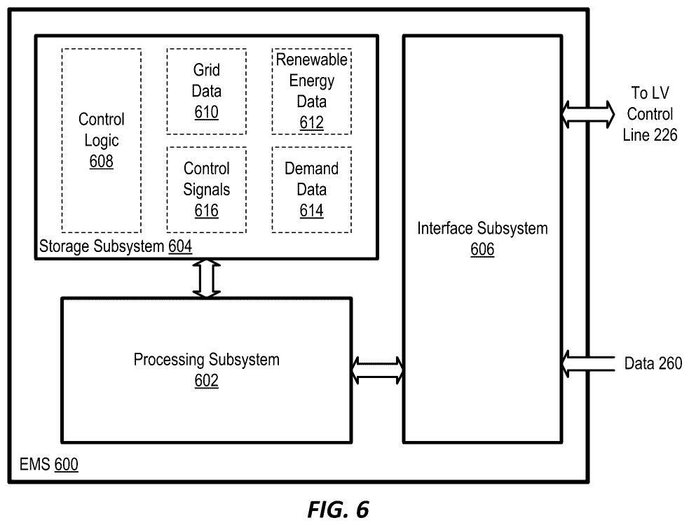

FIG. 6 is a block diagram of an EMS 600, which is one possible embodiment of EMS 224. EMS 600 includes a processing subsystem 602, a storage subsystem 604, and an interface subsystem 606. Processing subsystem 602 is communicatively coupled to each of storage subsystem 604 and interface subsystem 606. Although processing subsystem 602, storage subsystem 604, and interface subsystem 606 are depicted as being single elements, each of these elements could be embodied by two or more sub elements that need not be collocated. For example, one or more of processing subsystem 602 and storage subsystem 604 could be at least partially embodied by a distributed computing system, such as a cloud computing system. Additionally, two or more of processing subsystem 602, storage subsystem 604, and interface subsystem 606 could be partially or fully combined. Interface subsystem 606 provides an interface between EMS 600 and external elements. For example, low voltage data control line 226 is communicatively coupled to EMS 600 via interface subsystem 606, and EMS 600 receives data 260 via interface subsystem 606.

Storage subsystem 604 stores information, such as instructions and/or data, for use by EMS 600. For example, processing subsystem 602 is depicted as storing control logic 608, grid data 610, renewable energy data 612, demand data 614, and control signals 616. Grid data 610 is, for example, current, predicted, and/or historical data related to AC electric power grid 206. Similarly, renewable energy data 612 is, for example, current, predicted, and/or historical data related to PV electric power source 204 and/or other renewable electric power sources 208. Demand data 614 is, for example, data associated with current, predicted, and/or historical data related to demand for charging of EVs by EV charging stations 216. Control signals 616 are signals generated by EMS 600 for communicatively coupling to elements of XFC system 202 via low voltage data control line 226. For example, in some embodiments, control signals 616 include control signals Φ1, Φ2, Φ3, Φ4, and Φ5 discussed above with respect to FIG. 4. Control logic 608 is instructions for processing subsystem 602 to execute, such as based on one or more of grid data 610, renewable energy data 612, and demand data 614, to generate control signals 616. For example, in an embodiment, (i) renewable energy data 612 represents anticipated output of PV electric power source 204 and/or other renewable electric power sources 208, (ii) grid data 610 represents cost of electric power received from AC electric power grid 206, (iii) demand data 614 represents anticipated demand for use of EV charging stations 216, and (iv) processing subsystem 602 is configured to execute control logic 608 to generate control signals for controlling controller 212 at least partially based on the anticipated output of PV electric power source 204, the cost of electric power received from AC electric power grid 206, and the anticipated demand for use of EV charging stations 216.

Referring again to FIG. 2, EV charging stations 216 are configured to charge batteries of EVs. It should be appreciated that EV charging stations 216 are powered from a DC electric power source instead of an AC power source, as EV charging stations 216 are electrically coupled to DC electric power buses 238 without use of rectification circuitry. As such, electric power flows from batteries 214, PV electric power source 204, other renewable electric power sources 208, and/or PCS 256, to EV charging stations 216 and EV batteries being charged therefrom solely in the DC domain and accordingly without converting between DC electric power and AC electric power. Powering of EV charging stations 216 from a DC electric power source advantageously eliminates losses from rectification, i.c., converting AC power to DC power, that is necessarily performed in EV charging stations of conventional Level 3 charging systems. It should also be noted that the fact that XFC system 202 operates solely in the DC domain (other than its connection to AC electric power grid 206 via isolation transformer 254 and PCS 256), eliminates losses resulting from conversion between AC power and DC power in XFC system 202. Furthermore, batteries 214 provide a large energy source to EV charging stations 216 that typically cannot be realized via AC grid interconnects of conventional XFC charging systems, thereby enabling particular embodiments of XFC system 202 to charge EV batteries significantly faster than conventional Level 3 charging systems. For example, certain embodiments are capable of charging a battery of an EV at a rate of 360 Kilowatts (kW) or greater. Moreover, the fact that batteries 214 are electrically coupled to EV charging stations 216 solely in the DC domain, or stated differently, that there is no conversion between DC electric power and AC electric power in electrical energy paths between batteries 214 and EV charging stations 216, helps minimize restrictions in energy flow between batteries 214 and EV charging stations 216, thereby further enabling fast EV battery charging in XFC system 202.

Accordingly, particular embodiments depend significantly upon DC electric power sources to eliminate potential sources of energy loss, such as from converting AC electric power to DC electric power. Significant aspects of XFC system 202 include, but are not limited to, the all-DC electric power buses 232, 234, and 242 from renewable electric power sources through controller 212 to batteries 214, all-DC electric power buses 218 and 238 into EV charging stations 216, and EMS 224 which monitors and controls XFC system 202, as well as predicting environmental and other surrounding conditions that can affect the availability and cost of power to be stored and distributed to EV charging stations 216.

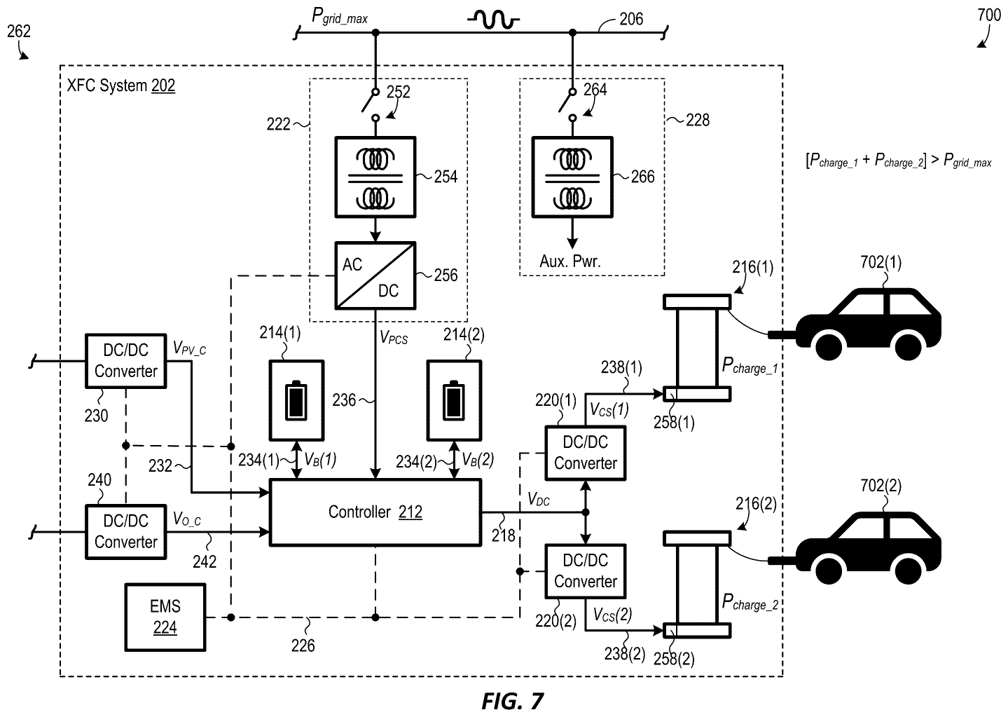

Additionally, the ability of XFC system 202 to use electric power from batteries 214, PV electric power source 204, and/or other renewable electric power sources 208 enables certain embodiments of XFC system 202 to have a capacity for charging batteries of EVs that exceeds a capacity of AC electric power grid 206 at a location 262 of XFC system 202. For example, FIG. 7 is a schematic diagram of an electrical environment 700, which is an embodiment of electrical environment 200 (FIG. 2) where XFC system 202 is capable of providing more electric power to vehicles that is available from AC electric power grid 206 at location 262 of XFC system 202. Each EV charging station 216(1) is charging a battery (not shown) of a respective EV 702 in electrical environment 700. A magnitude of electric power flowing to EV charging station 216(1) is P_{charge_1}, a magnitude of electric power flowing to EV charging station 216(2) is P_{charge_2}, and a capacity of AC electric power grid 206 at location 262 is P_{grid_max} A sum of P_{charge_1} and P_{charge_2} is greater than P_{grid_max}, such that a collective magnitude of electric power flowing to EV charging stations 216 exceeds the capacity AC electric power grid 206 at location 262. Electric power flows from batteries 214 to EV charging stations 216, for example, to enable XFC system 202 to have a capacity for charging batteries of EVs 702 that exceeds the capacity of AC electric power grid 206 at location 262. PV electric power source 204, other renewable electric power sources 208, and power disconnect switch 210 are not shown in FIG. 7 for illustrative clarity.

Referring again to FIG. 2, in order to operate XFC system 202, especially when energizing XFC system 202 for the first time, it may be necessary to use auxiliary power system 228 to power some elements of XFC system 202, such as controller 212 and EMS 224. Auxiliary power system 228 includes a power disconnect switch 264 and an isolation transformer 266. Auxiliary power system 228 is energized/de-energized via power disconnect switch 264, and isolation transformer 266 protects AC electric power grid 206 as well as equipment of XFC system 202 connected to AC electric power grid 206. Auxiliary power system 228 may include additional elements, such as rectification circuitry (not shown) and a DC/DC converter (not shown).

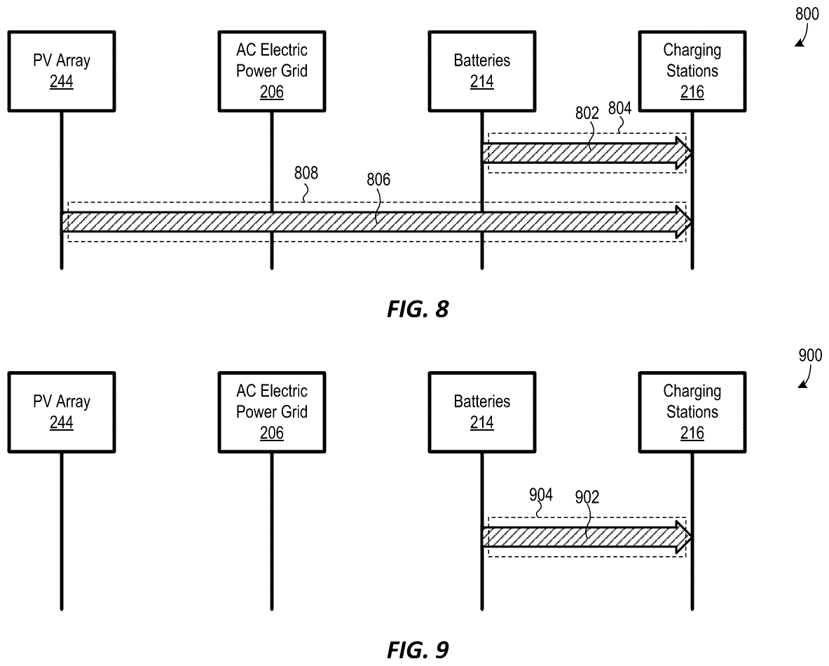

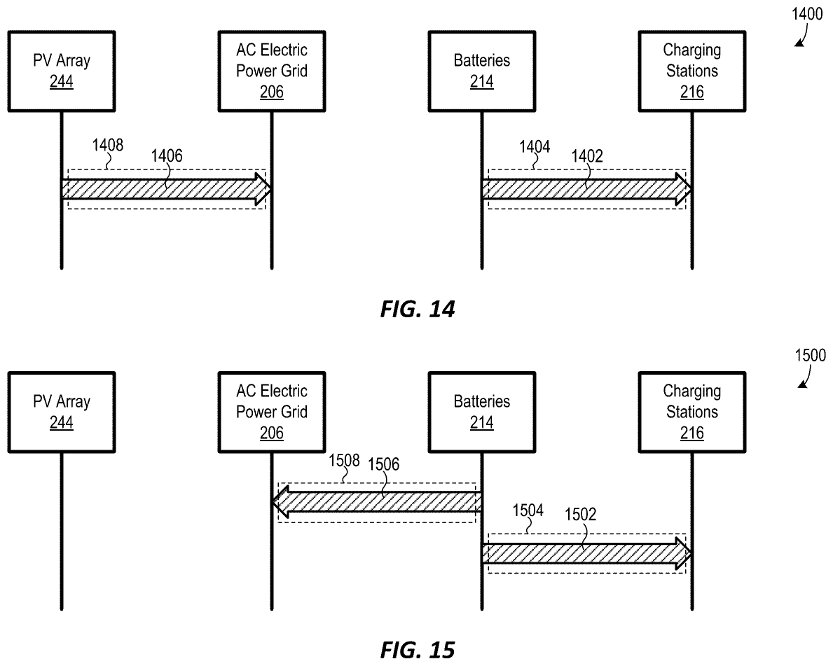

FIGS. 8-15, disclosed below, illustrate several examples of electric power flow in electrical environment 200. It is understood, though, that power flow in electrical environment 200 is not limited to the examples of electric power flow of FIGS. 8-15. Additionally, not all embodiments of XFC system 202 are necessarily capable of supporting all of the example power flows of FIGS. 8-15. For example, in certain embodiments of XFC system 202, controller 212 does not include the requisite switching devices for supporting the examples of electric power flow of FIGS. 14 and 15.

Each of FIGS. 8-15 includes respective vertical lines logically representing each of PV array 244, AC electric power grid 206, batteries 214, and EV charging stations 216. FIG. 8 is an illustration 800 of example power flow in electrical environment 200 where batteries 214 and PV array 244 jointly power EV charging stations 216. Specifically, electric power 802 flows from batteries 214 to EV charging stations 216 via a path 804, where path 804 includes DC electric power buses 234, controller 212, main DC electric power bus 218, DC/DC converters 220, and DC electric power buses 238 (not shown in FIG. 8). Additionally, electric power 806 flows from PV array 244 to EV charging stations 216 via a path 808, where path 808 includes optimizer circuitry 246, combiner box 248, power disconnect switch 250, DC/DC converter 230, DC electric power bus 232, controller 212, main DC electric power bus 218, DC/DC converters 220, and DC electric power buses 238 (not shown in FIG. 8). XFC system 202 may operate according to the example of FIG. 8, for example, when PV electric power source 204 is available but is not producing sufficient electric power to provide all electric power required by EV charging stations 216.

FIG. 9 is an illustration 900 of an example of power flow in electrical environment 200 where solely batteries 214 power EV charging stations 216. In this example, electric power 902 flows from batteries 214 to EV charging stations 216 via a path 904, where path 904 includes DC electric power buses 234, controller 212, main DC electric power bus 218, DC/DC converters 220, and DC electric power buses 238 (not shown in FIG. 9). XFC system 202 may operate according to the example of FIG. 9, for example, when PV electric power source 204 is unavailable and batteries 214 are sufficiently charged to provide all electric power required by EV charging stations 216.

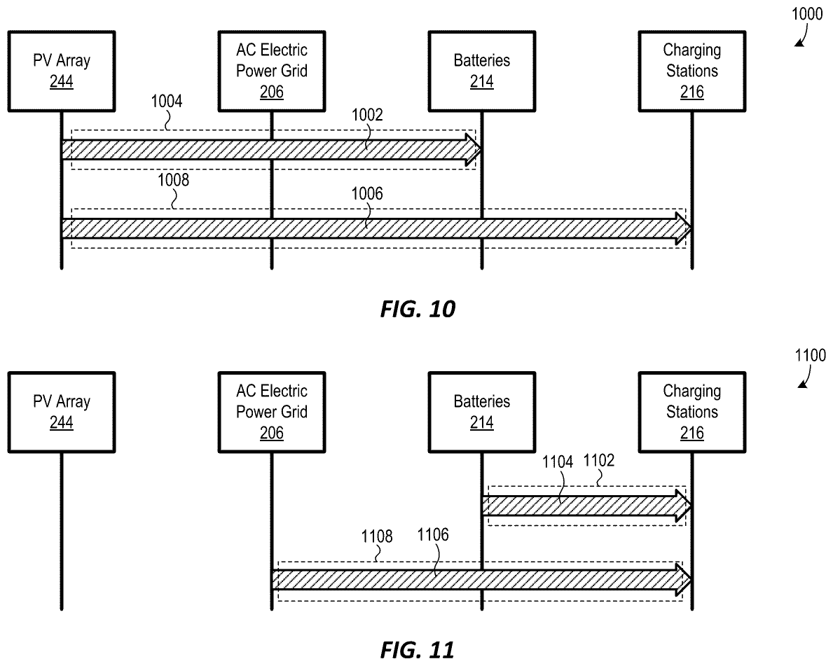

FIG. 10 is an illustration 1000 of an example of power flow in electrical environment 200 where PV array 244 simultaneously charges batteries 214 and powers EV charging stations 216. Specifically, electric power 1002 flows from PV array 244 to batteries 214 via a path 1004, where path 1004 includes optimizer circuitry 246, combiner box 248, power disconnect switch 250, DC/DC converter 230, DC electric power bus 232, controller 212, and DC electric power buses 234 (not shown in FIG. 10). Additionally, electric power 1006 flows from PV array 244 to EV charging stations 216 via a path 1008, where path 1008 includes optimizer circuitry 246, combiner box 248, power disconnect switch 250, DC/DC converter 230, DC electric power bus 232, controller 212, main DC electric power bus 218, DC/DC converters 220, and DC electric power buses 238 (not shown in FIG. 10). XFC system 202 may operate according to the example of FIG. 10, for example, when PV array 244 is producing a large amount of electric power.

FIG. 11 is an illustration 1100 of example power flow in electrical environment where AC electric power grid 206 and PV array 244 jointly power EV charging stations 216. Specifically, electric power 1102 flows from batteries 214 to EV charging stations 216 via a path 1104, where path 1104 includes DC electric power buses 234, controller 212, main DC electric power bus 218, DC/DC converters 220, and DC electric power buses 238 (not shown in FIG. 11). Additionally, electric power 1106 flows from AC electric power grid 206 to EV charging stations 216 via a path 1108, where path 1108 includes AC electric power source 222, DC electric power bus 236, controller 212, main DC electric power bus 218, DC/DC converters 220, and DC electric power buses 238 (not shown in FIG. 11). XFC system 202 may operate according to the example of FIG. 11, for example, when PV electric power source 204 is unavailable and batteries 214 are not sufficiently charged to provide all electric power required by EV charging stations 216.

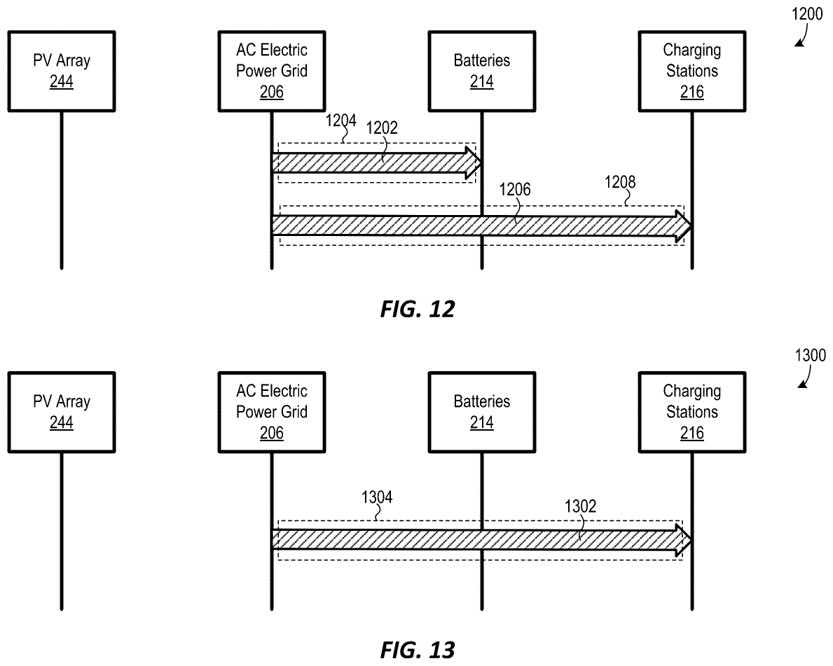

FIG. 12 is an illustration 1200 of an example power flow in electrical environment 200 where AC electric power grid 206 simultaneously charges batteries 214 and powers EV charging stations 216. Specifically electric power 1202 flows from AC electric power grid 206 to batteries 214 via a path 1204, where path 1204 includes AC electric power source 222, DC electric power bus 236, controller 212, and DC electric power buses 234 (not shown in FIG. 12). Additionally, electric power 1206 flows from AC electric power grid 206 to EV charging stations 216 via a path 1208, where path 1208 includes AC electric power source 222, DC electric power bus 236, controller 212, main DC electric power bus 218, DC/DC converters 220, and DC electric power buses 238 (not shown in FIG. 12). XFC system 202 may operate according to the example of FIG. 12, for example, when cost of electric power from AC electric power grid 206 is relatively low.

FIG. 13 is an illustration 1300 of an example of power flow in electrical environment 200 where solely AC electric power grid 206 powers EV charging stations 216. In this example, electric power 1302 flows from AC electric power grid 206 to EV charging stations 216 via a path 1304, where path 1304 includes AC electric power source 222, DC electric power bus 236, controller 212, main DC electric power bus 218, DC/DC converters 220, and DC electric power buses 238 (not shown in FIG. 13). XFC system 202 may operate according to the example of FIG. 13, for example, when batteries 214 are discharged and cost of electric power from AC electric power grid 206 is relatively high.

FIG. 14 is an illustration 1400 of an example of power flow in electrical environment 200 where solely batteries 214 power EV charging stations 216 and electric power produced by PV array 244 is provided to AC electric power grid 206. Specifically, electric power 1402 flows from batteries 214 to EV charging stations 216 via a path 1404, where path 1404 includes DC electric power buses 234, controller 212, main DC electric power bus 218, DC/DC converters 220, and DC electric power buses 238 (not shown in FIG. 14). Additionally, AC electric power 1406 flows from PV array 244 to AC electric power grid 206 via a path 1408, where path 1408 includes optimizer circuitry 246, combiner box 248, power disconnect switch 250, DC/DC converter 230, DC electric power bus 232, controller 212, DC electric power bus 236, and AC electric power source 222 (not shown in FIG. 14). XFC system 202 may operate according to the example of FIG. 14, for example, when batteries 214 are substantially charged, PV array 244 is producing significant electric power, and an operator of AC electric power grid 206 is willing to purchase electric power at a relatively high price.

FIG. 15 is an illustration 1500 of an example of power flow in electrical environment 200 where batteries 214 power EV charging stations 216 and batteries 214 also provide electric power to AC electric power grid 206. Specifically, electric power 1502 flows from batteries 214 to EV charging stations 216 via a path 1504, where path 1504 includes DC electric power buses 234, controller 212, main DC electric power bus 218, DC/DC converters 220, and DC electric power buses 238 (not shown in FIG. 15). Additionally, electric power 1506 flows from batteries 214 to AC electric power grid 206 via a path 1508, where path 1508 includes DC electric power buses 234, controller 212, DC electric power bus 236, and AC electric power source 222 (not shown in FIG. 15). XFC system 202 may operate according to the example of FIG. 15, for example, when batteries 214 are substantially charged and an operator of AC electric power grid 206 is willing to purchase electric power at a relatively high price.

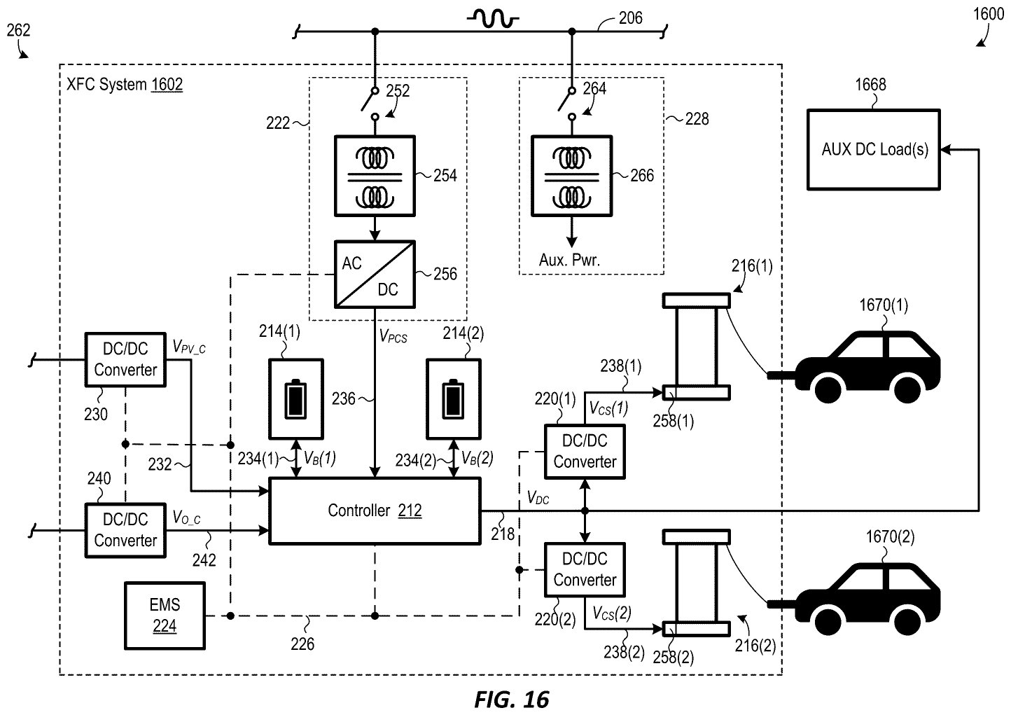

Modifications to XFC system 202 are possible. For example, FIG. 16 is a schematic diagram of an electrical environment 1600 including an XFC system 1602 in place of XFC system 202, where XFC system 1602 differs from XFC system 202 in that main DC electric power bus 218 extends beyond XFC system 1602 to power one or more auxiliary (AUX) DC loads 1668. AUX DC loads 1668 include, for example, one or more loads at an EV charging facility, such as lighting loads, security equipment loads, communication equipment loads, etc. FIG. 16 also depicts each EV charging station 216 charging the battery (not shown) of a respective EV 1670. PV electric power source 204, other renewable electric power sources 208, and power disconnect switch 210 are not shown in FIG. 16 for illustrative clarity.

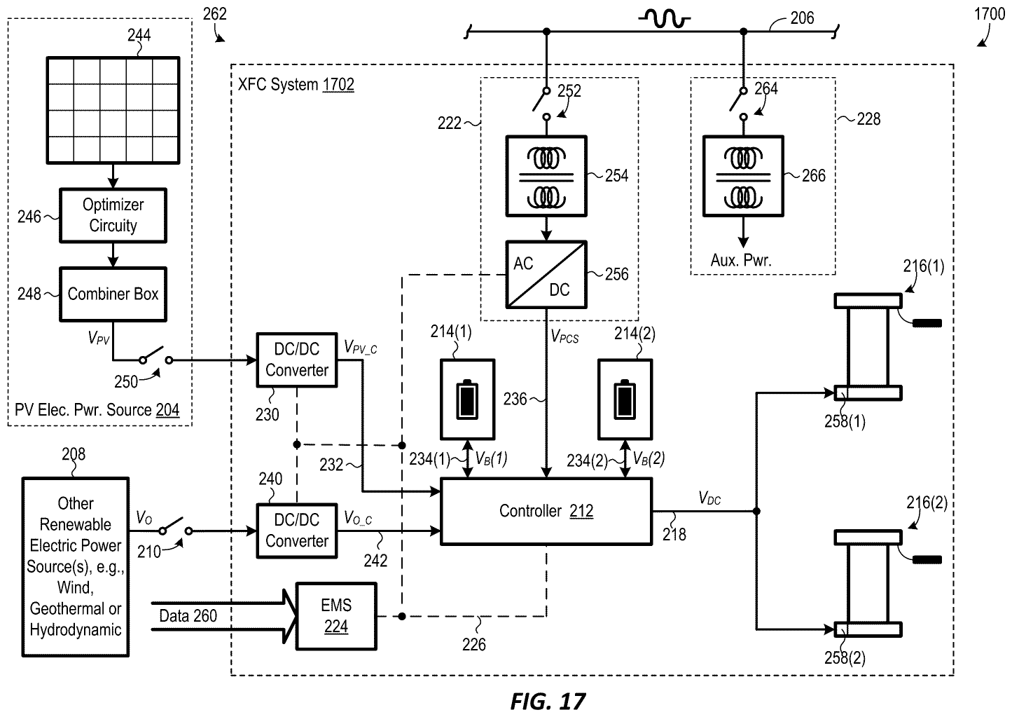

As another example of a possible modification of XFC system 202, FIG. 17 is a schematic diagram of an electrical environment 1700 including an XFC system 1702 in place of XFC system 202. XFC system 1702 differs from XFC system 202 in that voltage magnitude V_{DC} on main DC electric power bus 218 is compatible with EV charging stations 216. Therefore, DC/DC converters 230 are omitted, and main DC electric power bus 218 is directly connected to DC-only inputs 258 of EV charging stations 216.

### Combinations of Features

Features described above may be combined in various ways without departing from the scope hereof. The following examples illustrate some possible combinations:

(A1) An extreme fast-charging (XFC) system for electric vehicles includes (i) a direct current (DC) electric power bus and (ii) an electric vehicle (EV) charging station electrically coupled to the DC electric power bus without use of rectification circuitry.

(A2) The XFC system denoted as (A1) may further include a controller configured to selectively electrically couple each of two or more electric power sources to the DC electric power bus.

(A3) In the XFC system denoted as (A2), the two or more electric power sources may include (a) one or more renewable electric power sources, (b) a power conversion system powered from an alternating current (AC) electric power grid, and (c) one or more batteries.

(A4) In the XFC system denoted as (A3), (i) the one or more renewable electric power sources may be a primary electric power source for the XFC system and (ii) the AC electric power grid may be a backup electric power source for the XFC system.

(A5) Either one of the XFC systems denoted as (A3) and (A4) may further include an energy management system (EMS) configured to control operation of the controller.

(A6) In the XFC system denoted as (A5), the EMS may be configured to control operation of the controller at least partially based on one or more (a) anticipated output of the one or more renewable electric power sources, (b) cost of electric power received from the AC electric power grid, and (c) anticipated demand for use of the EV charging station.

(A7) Any one of the XFC systems denoted as (A3) through (A6) may further include an auxiliary power system to power at least the controller when the one or more batteries are not capable of providing electric power for powering the controller.

(A8) In any one of the XFC systems denoted as (A3) through (A7), the one or more renewable electric power sources may include one or more of a photovoltaic electric power source, a wind electric power source, a hydrodynamic electric power source, and a geothermal electric power source.

(B1) An extreme fast-charging (XFC) system for electric vehicles includes (1) a connection to one or more renewable electric power sources, the one or more renewable electric power sources configured as a primary electric power source for the XFC system, (2) a power conversion system electrically powered from an alternating current (AC) electric power grid and configured to provide a backup electric power source to the XFC system, (3) one or more direct current (DC) electric energy storage systems, (4) one or more electric vehicle (EV) charging stations configured to be powered from DC electric power, and (5) a controller. The controller is configured to (i) selectively electrically couple the primary electric power source, the backup electric power source, and the one or more DC energy storage systems, to the one or more EV charging stations, for providing DC electric power to the one or more EV charging stations, and (ii) selectively electrically couple each of the primary electric power source and the backup electric power source to the one or more DC electric energy storage systems, for storing energy in the one or more DC electric energy storage systems.

(B2) The XFC system denoted as (B1) may further include an energy management system (EMS) configured to control operation of the controller at least partially based on one or more (1) anticipated output of the one or more renewable electric power sources, (2) cost of electric power received from the AC electric power grid, and (3) anticipated demand for use of the one or more EV charging stations,

(B3) In either one of the XFC systems denoted as (B1) and (B2), the one or more renewable electric power sources may include one or more photovoltaic electric power sources.

(B4) In any one of the XFC systems denoted as (B1) through (B3), the one or more renewable electric power sources may include one or more wind electric power sources.

(B5) In any one of the XFC systems denoted as (B1) through (B4), the one or more renewable electric power sources may include one or more hydrodynamic electric power sources.

(B6) In any one of the XFC systems denoted as (B1) through (B5), the one or more renewable electric power sources may include one or more geothermal electric power sources.

(B7) In any one of the XFC systems denoted as (B1) through (B6), the one or more DC electric energy storage systems may include one or more batteries.

(B8) In any one of the XFC systems denoted as (B1) through (B7), the one or more DC electric energy storage systems may include one or more inertial flywheel storage units.

(C1) A method for extreme fast-charging (XFC) of one or more electric vehicles includes (1) using a controller, electrically coupling one or more batteries to a direct current (DC) electric power bus and (2) powering one or more electric vehicle (EV) charging stations electrically coupled to the DC electric power bus without converting DC electric power on the DC electric power bus to alternating current (AC).

(C2) In the method denoted as (C1), electric current may flow from the one or more batteries to an EV being charged from a first EV charging station of the plurality of EV charging stations solely in a DC domain.

(C3) Either one of the methods denoted as (C1) and (C2) may further include charging the one or more batteries via a power conversion system (PCS) powered from an alternating current (AC) electric power grid.

(C4) In the method denoted as (C3), a magnitude of electric power flowing from the one or more batteries to the one or more EV charging stations may exceed a capacity of the AC electric power grid at a location of the XFC system.

(C4) Either one of the methods denoted as (C1) and (C2) may further include charging the one or more batteries from one or more renewable electric power sources.

(C5) Any one the methods denoted as (C1) through (C4) may further include selecting between a plurality of electric power sources for providing electric power to the DC electric power bus at least partially based on one or more (1) anticipated output of one or more renewable electric power sources electrically coupled to the controller, (2) cost of electric power from an AC electric power grid electrically coupled to the controller via a power conversion system, and (3) anticipated demand for use of the one or more EV charging stations.

Changes may be made in the above methods, devices, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which as a matter of language, might be said to fall therebetween.

What is claimed is:

1. An extreme fast-charging (XFC) system for electric vehicles, comprising:
a direct current (DC) electric power bus; and
an electric vehicle (EV) charging station electrically coupled to the DC electric power bus without use of rectification circuitry.

2. The XFC system of claim 1, further comprising a controller configured to selectively electrically couple each of two or more electric power sources to the DC electric power bus.

3. The XFC system of claim 2, wherein the two or more electric power sources comprise (a) one or more renewable electric power sources, (b) a power conversion system powered from an alternating current (AC) electric power grid, and (c) one or more batteries.

4. The XFC system of claim 3, wherein:
the one or more renewable electric power sources are a primary electric power source for the XFC system; and
the AC electric power grid is a backup electric power source for the XFC system.

5. The XFC system of claim 3, further comprising an energy management system (EMS) configured to control operation of the controller.

6. The XFC system of claim 5, wherein the EMS is configured to control operation of the controller at least partially based on one or more (a) anticipated output of the one or more renewable electric power sources, (b) cost of electric power received from the AC electric power grid, and (c) anticipated demand for use of the EV charging station.

7. The XFC system of claim 3, further comprising an auxiliary power system to power at least the controller when the one or more batteries are not capable of providing electric power for powering the controller.

8. The XFC system of claim 3, wherein the one or more renewable electric power sources comprise one or more of a photovoltaic electric power source, a wind electric power source, a hydrodynamic electric power source, and a geothermal electric power source.

9. An extreme fast-charging (XFC) system for electric vehicles, comprising:
a connection to one or more renewable electric power sources, the one or more renewable electric power sources configured as a primary electric power source for the XFC system;
a power conversion system electrically powered from an alternating current (AC) electric power grid and configured to provide a backup electric power source to the XFC system;
one or more direct current (DC) electric energy storage systems;
one or more electric vehicle (EV) charging stations configured to be powered from DC electric power; and
a controller configured to:
selectively electrically couple the primary electric power source, the backup electric power source, and the one or more DC energy storage systems, to the one or more EV charging stations, for providing DC electric power to the one or more EV charging stations, and
selectively electrically couple each of the primary electric power source and the backup electric power source to the one or more DC electric energy storage systems, for storing energy in the one or more DC electric energy storage systems.

10. The XFC system of claim 9, further comprising an energy management system (EMS) configured to control operation of the controller at least partially based on one or more (a) anticipated output of the one or more renewable electric power sources, (b) cost of electric power received from the AC electric power grid, and (c) anticipated demand for use of the one or more EV charging stations.

11. The XFC system of claim 9, wherein the one or more renewable electric power sources comprise one or more photovoltaic electric power sources.

12. The XFC system of claim 9, wherein the one or more renewable electric power sources comprise one or more of a wind electric power source, a hydrodynamic electric power source, and a geothermal electric power source.

13. The XFC system of claim 9, wherein the one or more DC electric energy storage systems comprise one or more batteries.

14. The XFC system of claim 9, wherein the one or more DC electric energy storage systems comprise one or more inertial flywheel storage units.

15. A method for extreme fast-charging (XFC) of one or more electric vehicles, the method comprising:
using a controller, electrically coupling one or more batteries to a direct current (DC) electric power bus; and
powering one or more electric vehicle (EV) charging stations electrically coupled to the DC electric power bus without converting DC electric power on the DC electric power bus to alternating current (AC).

16. The method of claim 15, wherein electric current flows from the one or more batteries to an EV being charged from a first EV charging station of the plurality of EV charging stations solely in a DC domain.

17. The method of claim 15, further comprising charging the one or more batteries via a power conversion system (PCS) powered from an alternating current (AC) electric power grid.

18. The method of claim 17, wherein a magnitude of electric power flowing from the one or more batteries to the one or more EV charging stations exceeds a capacity of the AC electric power grid at a location of the XFC system.

19. The method of claim 15, further comprising charging the one or more batteries from one or more renewable electric power sources.

20. The method of claim 15, further selecting between a plurality of electric power sources for providing electric power to the DC electric power bus at least partially based on one or more (a) anticipated output of one or more renewable electric power sources electrically coupled to the controller, (b) cost of electric power from an AC electric power grid electrically coupled to the controller via a power conversion system, and (c) anticipated demand for use of the one or more EV charging stations.
